(19) United States
(12) Patent Application Publication
(10) Pub. No.: US 2015/0199729 A1
(43) Pub. Date: Jul. 16, 2015

(54) METHODS AND SYSTEMS FOR DYNAMIC ADVERTISING ON MOBILE AND STATIONARY PLATFORMS

(71) Applicant: AdMobilize LLC., Miami Beach, FL (US)

(72) Inventor: Rodolfo Saccoman, Miami Beach, FL (US)

(21) Appl. No.: 14/594,082

(22) Filed: Jan. 10, 2015

Related U.S. Application Data
(60) Provisional application No. 61/926,582, filed on Jan. 13, 2014.

(51) Int. Cl. G06Q 30/02

(52) U.S. Cl. CPC G06Q 30/0269; G06Q 30/0261

(57) ABSTRACT

Systems, methods and devices for advertising on mobile and stationary platforms may comprise a beacon configured to obtain and communicate data related to a viewing session of a particular ad, and a server configured to receive the data, identify in the data a human face associated with a particular person, to extract a facial feature including a gaze factor from the face, and to process the facial feature and gaze factor into metrics to be delivered to an advertiser of the particular ad. In some embodiments, the beacon may dynamically control the display of a particular ad based on an extracted metric.

### CROSS REFERENCE TO RELATED APPLICATIONS

This application is related to and claims priority from U.S. Provisional Patent Application No. 61/926,582 having the same title and filed Jan. 13, 2014, which is incorporated herein by reference in its entirety.

### FIELD

Embodiments disclosed herein relate generally to advertising on mobile and stationary platforms and more particularly to beacons used to track, process and transmit data related to ads displayed on mobile as well as stationary platforms.

### BACKGROUND

U.S. patent application Ser. No. 13/851,970 titled “System and method for advertising on mobile platforms”, which is incorporated by reference in its entirety for all purposes set forth herein, teaches an advertising system (named “AdMobilize”) comprising a mobile platform (a car or another type of vehicle, or a tablet associated with an exhibitor (referred to hereinafter as an “AdMobilizer”) and used to exhibit a selected ad of an Advertiser and to obtain real time tracking data related to the selected ad, a server for processing the tracking data into desired metrics and for providing the metrics to the Advertiser and/or the AdMobilizer, and an Administrator for running the system and for approving and paying the AdMobilizer. The tracking data is obtained using a device called “beacon”. The beacon is described in more detail in FIG. 1. It can capture and communicate in real time tracking data. The tracking data is pushed to the server, where it is processed into desired metrics. The metrics are then provided (for example for visual display) to the AdMobilizer, Advertiser and Administrator via respective AdMobilizer, Advertiser, and Administrator portals.

FIG. 1 shows schematically an embodiment of a beacon 100 disclosed in U.S. patent application Ser. No. 13/851,970. The beacon includes a position/location module 102, a tracking data acquisition module 104, a communication module 106 and an ID reader 108. Position/location module 102 may include any known position locator, e.g. a global positioning system (GPS) transceiver or a cellular based locator. Tracking data acquisition module 104 may include a camera that images and video records the cars or drivers viewing the ad. Communication module 106 may include cellular or other wireless communication capabilities. In general, the beacon is operative to capture tracking data, for example by (viewing) session. The tracking data may include a beacon ID, a beacon status (e.g. ON, OFF, a status indicating that communication occurs), an ad ID (obtained from the respective ID tag, normally an RFID tag attached to the ad), GPS (or otherwise acquired) coordinates, a time stamp (beginning and end of ad display session), a route over which the ad is displayed, images of cars or people viewing a particular ad over the given session and people or car counts. The tracking data is communicated by module 106 through an antenna 110 to the system server. The beacon may be powered by the car battery, through a charger and power cable 112, or it may have its own power source (not shown).

The processing of certain real time tracking data obtained by a beacon (wherein the beacon is either mobile or stationary) into metrics that provide value to an advertiser is very desirable. For example, there is a need for and it would be advantageous for an advertiser to receive various “pay-per-feature” metrics. These may include (but not be limited to) pay-per-face, pay-per-gaze, pay-per-look, pay-per-emotion, pay-per-demographics, pay-per-vehicle or pay-per-object. There is further a need for, and it would be advantageous to have “dynamic” ads that are exhibited in response to metrics obtained by a mobile or stationary beacon, with such dynamic ads being controlled by or through the beacon.

As used herein, “demographics” refers to any classifiable characteristic that can be used to categorize human beings and/or other objects such as vehicles to provide for an optimized advertising solution for advertisers. For example, bariatric hospitals would prefer to advertise at geographical areas wherein the density of obese people is greater and avoid advertising in areas where such density is smaller. Thus, obesity is a “demographics” classification (also referred to as attribute or parameter) for advertising. Skin tone, sex. ethnicity and baldness of people are additional examples of demographics classifications. Similarly, the type of vehicle on a road can be classified as a sports utility vehicle (SUV), a sedan or a truck for optimized advertising and thus form vehicle demographics.

As used herein, “dynamic” advertising is a form of advertising wherein the ad being displayed can be altered or changed automatically (electronically) according to predefined conditions. Consider for example a wending machine in a mall with an electronic display screen used to display ad images. Using dynamic advertising, when an obese person is found in front of the machine the display may choose an ad of a nearby bariatric hospital. Similarly, it may display an ad of on-going promotion on an item being vended. There can be various other instances where dynamic advertising can be utilized for the benefit of the consumer, the manufacturer and other entities.

### SUMMARY

Embodiments disclosed herein relate to systems, methods and devices for advertising on mobile and stationary platforms. In particular, some embodiments disclosed herein teach beacons (termed “AdBeacons”) with novel and unobvious functionalities, and systems and methods including and using such AdBeacons. In some embodiments, an AdBeacon disclosed herein is configured to change display ads through communication with a dedicated AdMobilize server (referred to henceforth simply as “server”), while choosing the mode of communication through use of special firmware and not through use of an operating system. This functionality is achieved using minimal memory requirements and a split of the hardware into multiple boards. This type of split hardware design allows for easier addition and removal of features to the beacon, with minimal hardware and firmware modifications. In an embodiment, an AdBeacon has all its required firmware functionality built into 128 KB on each of two boards. In another embodiment, additional boards may be appended to the existing AdBeacon exclusively for HDMI output. The firmware may be installed without use of special storage devices such as Secure Digital (SD) cards. In an embodiment, an AdBeacon may take pictures of a scene with viewers of the selected ad and communicate the information to the server for further processing. The processing may include face, gaze or look detection, face counts, vehicle detection and classification at given locations and database maintenance. In an embodiment, some of the processing may be performed by the AdBeacon firmware itself.

In an embodiment, an AdBeacon may be used as a dynamic electronic sticker, termed herein “AdSticker”. The AdSticker may use e-ink paper technology to display a dynamic ad.

In an embodiment, there is provided a system comprising a beacon configured to obtain and communicate data related to a viewing session of a particular ad, and a server configured to receive the data, identify in the data a human face associated with a particular person, to extract a facial feature including a gaze factor from the face, and to process the facial feature and gaze factor into metrics related to the particular ad.

In an embodiment, there is provided a system comprising a server, a display for displaying a particular ad on a screen and a beacon coupled to server and the display and configured to change dynamically the particular ad based on a command received from the server.

In an embodiment, there is provided a method comprising the steps of providing a beacon configured to obtain and communicate data related to an ad viewing session ad to an ad server, processing the data to obtain demographics information, and using the demographics information to extract a metric related to the ad, the metric being used to set a payment policy for the ad.

In an embodiment, the facial features include a face dimension and a pair of eyes separated by an inter-eye distance and wherein the gaze factor includes a gaze direction relative to the particular ad.

In an embodiment, the facial feature processing results in a ratio between the inter-eye distance and the face dimension and wherein the metric includes a demographics metric related to the ratio.

In an embodiment, the demographics metric includes a person's approximate weight.

In an embodiment, the demographics metric includes a person's approximate ethnicity.

In an embodiment, the data further includes a location and a timestamp.

In an embodiment, the beacon in installed on a mobile platform.

In an embodiment, the beacon in installed on a stationary platform.

In an embodiment, the beacon is further configured to display a dynamic ad on a screen in response to an input received from the server.

In an embodiment, the beacon includes two boards communicating through a serial port, wherein a first board includes a first microcontroller, a camera for taking images and a High-Definition Multimedia Interface (HDMI) interface that connects the beacon to an external display, and wherein a second board includes a second microcontroller and a Bluetooth module for communicating the data to the server, the first and second microcontrollers operative to control functions of respective board elements.

In an embodiment of a method, the method further comprises the step of setting a pay-per-metric policy for the ad based on the particular metric.

In an embodiment of a method, the method further comprises the steps of coupling the beacon to a display displaying the particular ad and controlling dynamically the display of a particular ad through the beacon

In an embodiment of a method, the step of controlling dynamically includes, by the ad server, providing the beacon with a command to display the particular ad, the command based on the metric.

### BRIEF DESCRIPTION OF THE DRAWINGS

Non-limiting embodiments are herein described, by way of example only, with reference to the accompanying drawings, wherein:

FIG. 1 shows schematically an embodiment of an AdBeacon disclosed in U.S. patent application Ser. No. 13/851,970;

FIG. 2 shows an embodiment of the dynamic advertising system with database creation;

FIG. 3 shows an embodiment of an AdBeacon disclosed herein;

FIG. 4 shows an embodiment of a sticker disclosed herein;

FIG. 5 shows an embodiment of a data packet disclosed herein;

FIG. 6 shows an embodiment of beacon firmware disclosed herein;

FIG. 7 shows an embodiment of algorithm for choice of communication mode;

FIG. 8 shows an embodiment of a command packet for Bluetooth communication;

FIG. 9 shows schematically in a flowchart a method to detect and classify people and vehicles from beacon-acquired data as disclosed herein;

FIG. 10 shows schematically a vending machine in a mall with an ad of the Gap-brand;

FIG. 11 shows schematically an AdBeacon disclosed herein coupled to a billboard display for dynamic display of ads sent from a server;

FIG. 12 shows schematically an AdBeacon disclosed herein placed on a billboard on a road travelled by vehicles.

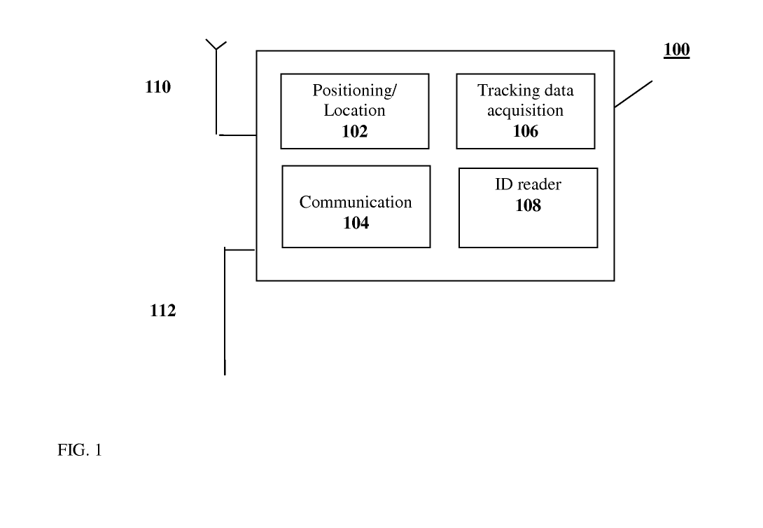

### DETAILED DESCRIPTION

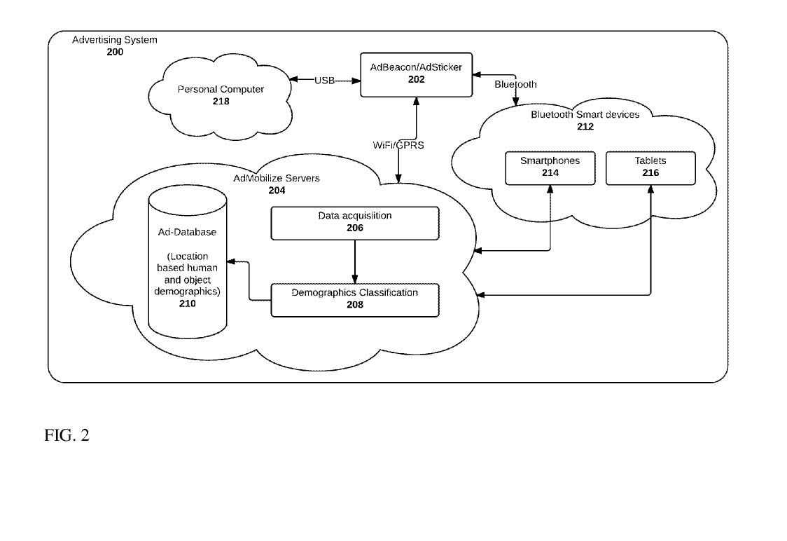

FIG. 2 shows an embodiment of advertising system disclosed herein and numbered 200. System 200 comprises an AdBeacon (or Adsticker) 202 communicatively coupled to an AdMobilize server 204 that includes a data acquisition module 206, a demographics classification module 208 and an ad database 210. The communication may exemplarily be via WiFi or general packet radio service (GPRS). Both beacon 202 and server 204 may communicate with one or more Bluetooth enabled smart devices 212 (for example a smartphone 214 or a tablet 216) and with one or more personal computers (PC) 218.

In use, AdBeacon 202 takes images of a scene with viewers viewing a particular ad and transmits image and other data to server 204 either directly using WiFi or GPRS or indirectly. The latter is done by first relaying the image data to a smart-phone or a tablet using Bluetooth. The data is then sent by the respective device to the server. In the server, the data is first acquired by data acquisition module 206, which extracts information such as GPS location, time stamp, actual image data and AdBeacon ID. The image data is analyzed by the demographics classification module 208. The result of the classification and the corresponding information of GPS location, time stamp and AdBeacon ID are stored in database 210. This database is unique in that it can be utilized to provide statistical information of demographics of humans and objects like vehicles, including their location. The statistical information may be used by advertisers to display appropriate ads at appropriate locations to suit their requirements, to perform market analysis and to design appropriate strategies. For example, such information may be used by a company like Nike to identify locations where its ads were viewed most often but where there is no nearby Nike shop. Nike can then take appropriate measures to improve sales and marketing. Similarly, the database information may be used to mark prices at certain locations in response to ad-viewers' flow, physical characteristics, etc. The AdBeacon may be programmed through PC 218. The PC may also be used to update the firmware on the AdBeacon.

FIG. 3 shows in more details an embodiment of an AdBeacon 202. AdBeacon 202 comprises a first board A 302 and a second board B 304, the two boards communicating with each other using a serial port 306 and unique communication protocols and commands. Port 306 may be a universal synchronous asynchronous receiver and transmitter (USART) port. Board A controls a power circuit and a camera (see below), while board B communicates with server 204 and with Bluetooth enabled smart devices 212. Board A includes a microcontroller (μC) 302a, a camera 308, a battery management module 310, a USB device 312 and a HDMI interface 324. Board B includes a microcontroller 304a, a Bluetooth module 314 a GPRS module 316, a radio-frequency identification (RFID) module 318, a GPS module 320 and a WiFi communication module 322. The camera on board A may exemplarily be based on a 5 MP module. The microcontroller may be a simple 8-bit/16-bit μC with universal serial bus (USB), I²C, universal synchronous asynchronous receiver transmitter (USART) and serial peripheral interface (SPI) interfaces and with 128 Kbytes of onboard memory. The split board design distributes the work load over the individual microcontrollers, thus improving the efficiency of the AdBeacon. The battery management module may be used to auto-detect an external power source, to automatically switch between two different power sources and to manage battery charging. USB device 312 allows the AdBeacon to communicate with a PC 218 using a USB protocol to perform the following (among other functions): charge the battery and power the AdBeacon, update firmware on the AdBeacon using software, and communicate with the Internet through the PC.

The USB feature may be provided by μC 302a and 304a using firmware, thus reducing the complexity of hardware design. Camera 308 may communicate with μC 302a using exemplarily I²C communication channels, and may send data to μC 302a as a sequence of 8-bit data buffered through a first-in-first-out (FIFO) memory (not shown).

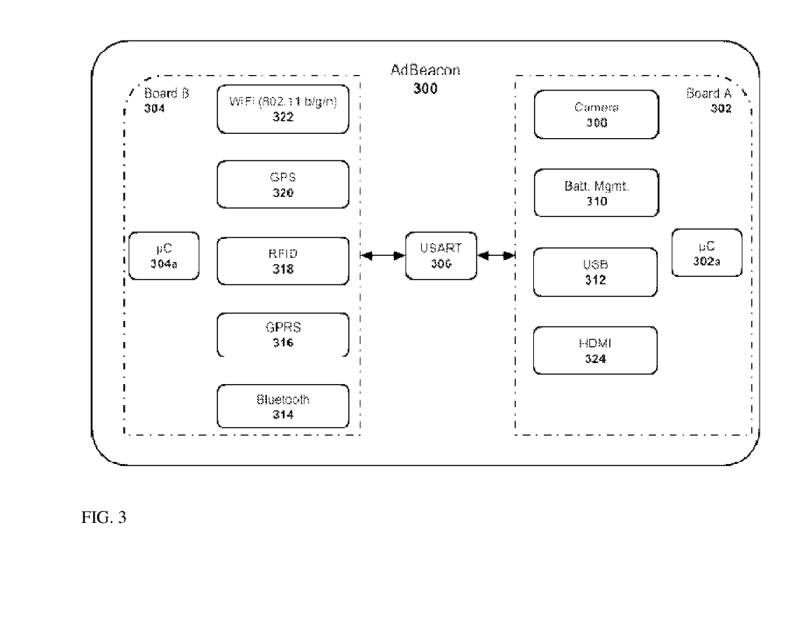

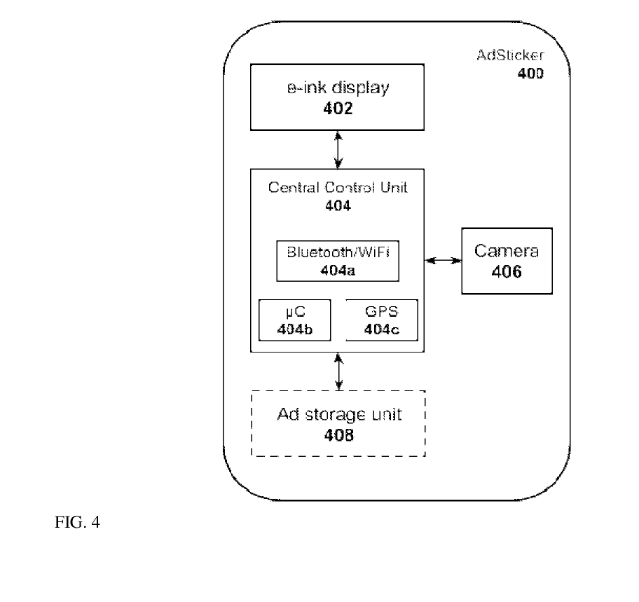

HDMI module 324 connects the AdBeacon to an external display (see 1102 in FIG. 11). The HDMI module enables the AdBeacon to display ads on the display screen, thus converting the display screen into a digital billboard. When the AdBeacon is an AdSticker (see FIG. 4), an e-ink display screen 402 may be attached to the AdBeacon using the HDMI interface and used to display ads on the AdBeacon itself.

In some embodiments of the AdBeacon, some of modules on board B may be optional. For example, if the AdBeacon is positioned in a static location, the RFID and GPRS modules may be optional and can be eliminated, reducing the costs.

Bluetooth module 314 may use a low-power Bluetooth 4.0 protocol to communicate with devices such as smart-phones and tablets to perform the following functions, using proprietary software running on the phone.
(i) Control the AdBeacon with a smart-phone or a tablet to turn ON and OFF;
(ii) Reduce extra data charges by turning off the GPRS module, using instead the smart-phone or tablet's available Internet connection;
(iii) Provide device information like battery level, the ad being displayed, etc.;
(iv) Control the camera capture rate;
(v) Set up WiFi connectivity parameters for the AdBeacon.

Exemplarily, every 5 min, the AdBeacon reads an ad ID tag to confirm the existence of a connected ad. In an embodiment, RFID module 318 may be used to program tags before they are distributed to advertisers. In some embodiments, near field communication (NFC) tags may be used instead of RFID tags.

GPS module 320 is utilized to geo-tag the images from the camera before these are sent to the server for processing. In some embodiments, GPS co-ordinates may be retrieved from the GPRS module. GPRS module 316 uses Internet connectivity provided by GSM service providers to connect to and communicate with AdMobilize servers.

WiFi module 322 is used to communicate to AdMobilize servers using an IEEE 802.11 b/g/n Internet protocol as a first priority protocol. This provides a cost effective and faster way of Internet communication when a WiFi hotspot is available for the device to connect to and access the Internet.

### AdSticker

FIG. 4 shows an embodiment of AdSticker 400. As explained, an AdSticker (or simply “sticker”) is a stripped down version of an AdBeacon. The AdSticker includes an e-ink based display 402, a central control unit (CCU) 404 and an optional camera 406. CCU 404 includes a Bluetooth/WiFi communications module 404a, a micro-controller 404b and a GPS module 404c. The CCU may receive ad images from a server using module 404a. These images may be stored in an optional ad storage unit 408. Once received, an image may be displayed on an e-ink based display 402. The CCU may use camera 406 to capture the image data, and along with the GPS co-ordinates from module 404c may relay the data to an AdMobilize server for further processing.

An AdSticker has the following characteristics:
1. It not include RFID, GPRS and HDMI modules;
2. Uses touch based e-ink papers for interactive ads;
3. The communication with a server may be strictly WiFi based;
4. If disposable, it may not need battery management.

### Firmware

In an exemplary implementation, different firmware is used for each board. In an embodiment, the firmware uses an ‘Embedded C’ structure converted to binary code using tools provided by the micro-controller manufacturers. The firmware is able to turn peripheral components ON and OFF as required, to conserve battery power. The firmware also generates data packets with image data and GPS co-ordinates, which are then sent to a remote server. This functionality is implemented without creating an operating system.

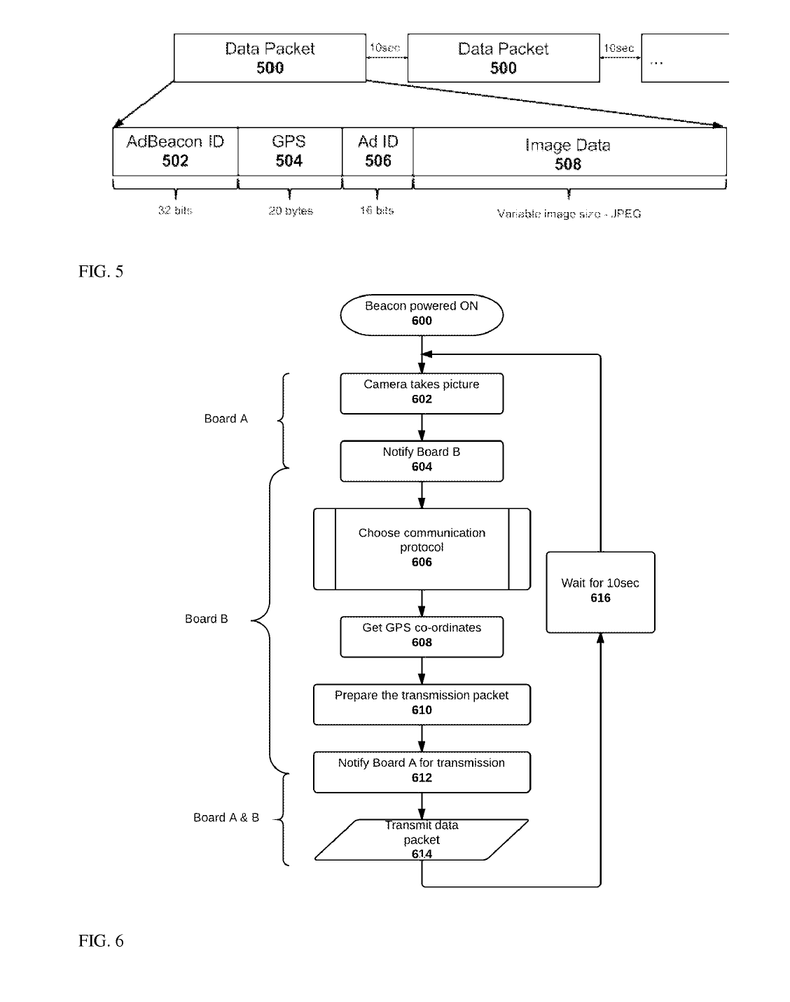

FIG. 5 shows an embodiment of an exemplary format of a data packet transmitted by an AdBeacon. Note that other formats may also be used. In FIG. 5, each data packet 500 starts with a 32-bit AdBeacon or sticker ID 502 followed by 20-bytes of GPS co-ordinates 504, a 16-bit Ad ID 506 and a variable length of image data 508. There may be a 10 sec time gap between two successive data packet transmissions. Each AdBeacon or AdSticker includes a 32-bit ID code 502. This enables to have 2³²=4,294,967,296 devices with unique IDs. When an AdBeacon or sticker is first registered by an end user, the ID of the AdBeacon or sticker is permanently associated with the user. This ID may be stored in the memory of μC 304b on board B. Similarly, each ad may be assigned a 16-bit ID code 504, thus allowing 2¹⁶=65,536 different ads. These bit length values are arbitrary and may be increased for scaling in the future. The camera-taken image is already JPEG compressed and hence the image size is not constant. However, for a 5 MP image compressed using the JPG90 standard, the typical file size is 750 kilo-byte. This results in a complete data packet 500 of size of 6000208 bits. Transmission of this data packet using the above recommended Class 10 and CS-4 GPRS module takes 150 s or approximately 2.5 min, while using the recommended WiFi it takes approximately 0.1 sec to 6 sec, depending on the connectivity speeds.

The firmware on an AdBeacon may run as described in a flowchart in FIG. 6. The AdBeacon is powered ON in step 600. Board A triggers the camera to take an image in step 602. Board A then notifies board B of a new image transmission over USART 302 in step 604. Board B chooses an appropriate transmission protocol from, in order, WiFi, Bluetooth or GPRS in step 606. Board B then obtains the GPS co-ordinates from the GPS module in step 608 and prepares a data packet 610 as previously explained with reference to FIG. 5. Board B then notifies board A that the necessary preparations for transmission are complete and the transmission is initiated by the AdBeacon in step 612. In step 614, board A keeps sending the image data until the entire image is transmitted to board B, which sends the data packet to a server. In step 616, the AdBeacon waits for a short period, e.g. 10 sec, after which the cycle repeats itself for the next data packet.

In an embodiment, the data packet may include continuous video data instead of single image data. In this case, the GPS information may be inserted into the video feed after every “N” number of bytes of video data so that the video location can be tracked. This is useful, especially when video is transmitted by an AdBeacon positioned on a moving platform.

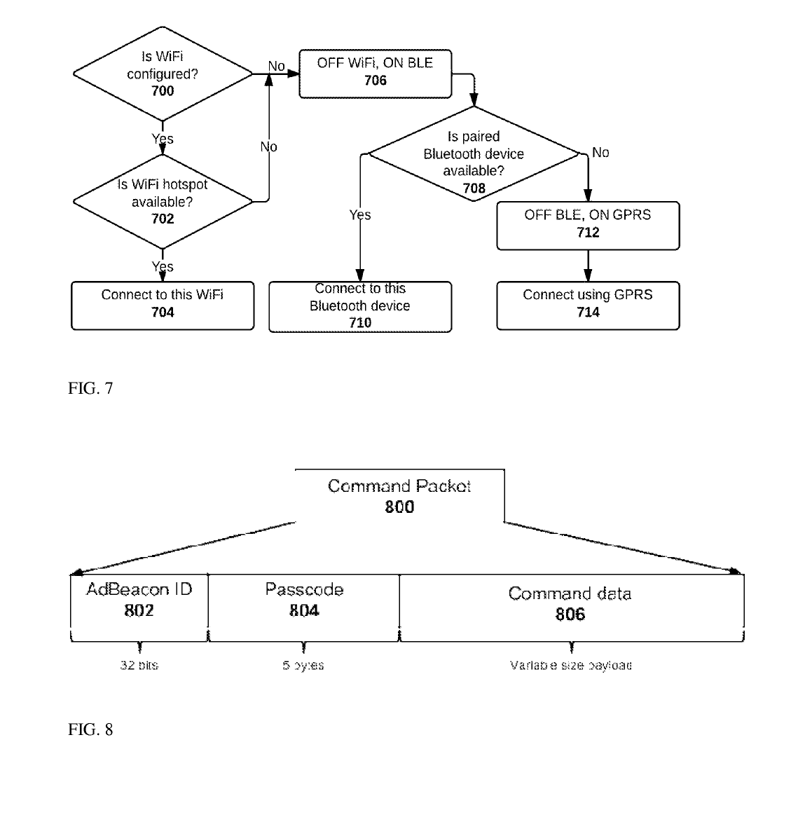

FIG. 7 shows more details of actions occurring in step 606. Initially, all communication modes (i.e. Bluetooth, GPRS and WiFi) are in OFF state. Board B checks if the WiFi mode is configured in step 700, and if yes, checks if a WiFi hotspot is available in step 702. If yes, board B connects to the WiFi hotspot in step 704 and uses the WiFi hotspot as the communication medium with AdMobilize servers. If, however, either the WiFi mode is not configured (NO in step 700) or a WiFi hotspot is unavailable (NO in step 702), then board B turns OFF the WiFi module and turns ON the Bluetooth module in step 706. Board B then further checks if a paired Bluetooth device is available in step 708. If YES, board B uses Bluetooth as communication mode with the paired device in step 710. If a paired Bluetooth device is unavailable in check 708, board B turns OFF the Bluetooth module, turns ON the GPRS module in step 712 and uses it for communication in step 714. The choice of an appropriate communication mode as described is advantageous in that it minimizes power consumption for memory and processing and provides a cost-effective mode of communication with the AdMobilize servers.

An application running on the server checks whether the images are valid and associates valid images with viewing sessions. Valid images are images with defined location coordinates associated with a particular AdBeacon or tablet and taken within defined boundaries of a viewing session i.e., between start and end time of a session. These images are processed at the server to gather location data, session data and timestamp data. The valid images may go through a stage of facial or body recognition using a face or body recognition application programming interface (API) in which information about eye gaze, skin color, obesity, body type and other characteristics is also extracted in addition to the conventional faces. Next, sentiment, gaze factors and demographics related to an image are generated and stored in a database. A “sentiment” may include for example a face being classified as “serious”, “smiling”, “crying”, or exhibiting another easily identifiable emotion. In an embodiment of the face recognition or body recognition API data will be in eXtended Markup Language (XML) for easy extraction. Further, the face recognition, gaze detection, body detection, look detection and sentiment data may be processed to provide statistical data.

Communication Via Bluetooth to Smart-Phones Running Proprietary Software to Control and Communicate with Ad Beacon

The communication signals from the smart-phone/tablet are first received by board B of the AdBeacon. The communication involves the selection of a particular AdBeacon based on the AdBeacon ID. FIG. 8 shows an embodiment of a command packet for Bluetooth communication. Each command packet 800 begins with the 32-bit AdBeacon ID 802 followed by a 5-byte passcode 804 uniquely assigned during the first pairing and finally by a payload 806 that includes command and associated data. The following examples illustrate various commands.

### Example 1

### Command from Smart-Phone to AdBeacon to Set-Up WiFi on the AdBeacon

A user opens an AdMobilize app on smart-phone by a user. Along with many other details, the app displays the parameters programmed on the AdBeacon e.g., the battery levels, type of connection used, the ad displayed and user account information. If not previously programmed for WiFi, the app provides the option to program one of the WiFi connections into the AdBeacon. Once an appropriate connection is chosen, the app transmits to the AdBeacon the command packet including the AdBeacon ID, the pass-code, and the command to program WiFi followed by the SSID and password of the chosen connection copied from the smart-phone's database.

### Example 2

### Command from AdBeacon to Smart-Phone—Battery Status

If the app on the smart-phone is open and the Bluetooth mode is connected, the beacon transmits the battery status information every 10 sec. This information begins with a 32-bit beacon ID, followed by the 5-byte passcode and a 1-byte payload. The first four bits of this payload classify it as a command for battery status and the next four bits indicate the battery level in grades of 1/16 of its full capacity. The battery status is communicated by board A to board B and then to the app on the smart-phone or tablet.

### Ad Metrics

The AdBeacon may collect and transmit the following data:
GPS
Timestamp
Images
Videos
RFID tags (usually placed on an ad itself, to identify that a particular ad is placed and exhibited? at the right location for the right time)

The image sent by the AdBeacon is then utilized by the AdMobilize servers 204 to obtain various statistics, such as the number of visitors (faces/vehicles/looks) based on the type of ad, location and time of day; comparative measure and tool for locations, and visitor demographics based pricing of ad spaces.

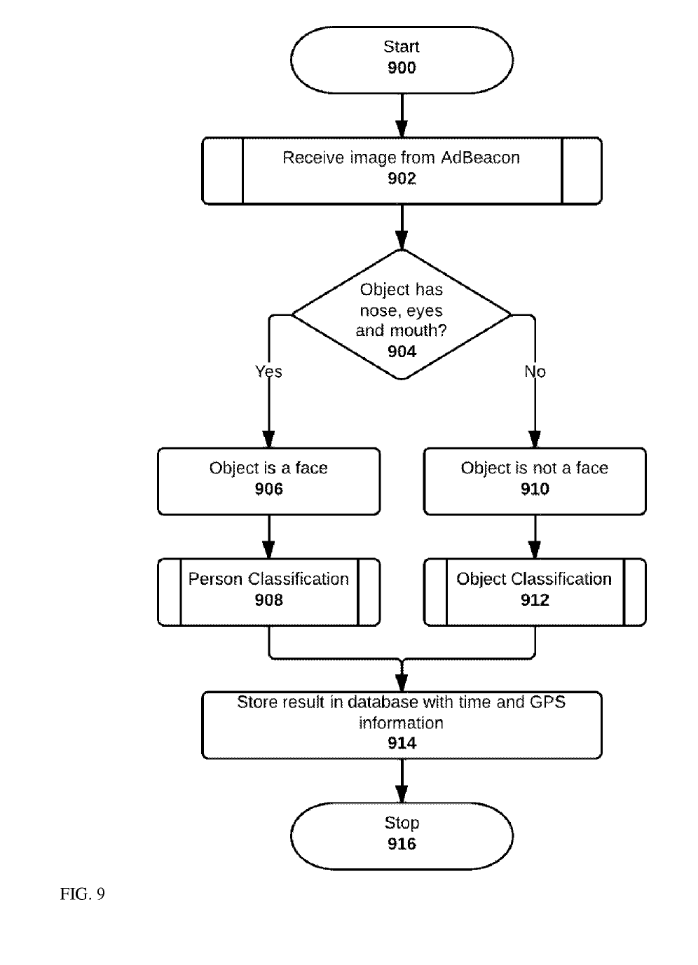

The data from the different AdBeacons arrives at a server, is processed, and along with the results is categorized in database that organize the information for processing and for providing the metrics outputs. Known algorithms of facial counting and facial recognition e.g., eigen-space based face recognition (Ki-Chung Chung; Seok-Cheol Kee; Sang-Ryong Kim, “Face recognition using principal component analysis of Gabor filter responses,” Recognition, Analysis, and Tracking of Faces and Gestures in Real-Time Systems, 1999. Proceedings. International Workshop on, vol., no., pp. 53,57, 1999 doi: 10.1109/RATFG.1999.799223), may be utilized to analyze every image. These algorithms identify different face features such as eyes, nose, mouth and face orientation or face rotation. The identified features may then be used to count a face, decide if the face was facing the camera, or identify if the eyeballs were looking in the direction of the camera or to an ad the AdBeacon is collecting data on. Additionally, the data is stored, and server-side algorithms may be used to recognize if the same face was looking at the camera to remove redundancy from the statistics. These results are provided as an input to a method to detect and classify people and vehicles from AdBeacon-acquired data. The method is described next with reference to FIG. 9. The method can provide good estimates of gender, race, age, and other information such as whether a person uses glasses or a hat, has a beard, etc. The same server-side algorithm may also determine if a vehicle is present in the image and if it is, classify the vehicle.

Method to Detect and Classify People and Vehicles from AdBeacon-Acquired Data

FIG. 9 shows schematically in a flowchart a method to detect and classify people and vehicles from AdBeacon-acquired data as disclosed herein. Image and associated data transmitted by the AdBeacon are received by a server in step 902. The object shape is analyzed for shape using known algorithms (see e.g. A Toshev et al., “Object detection via boundary structure segmentation,” 2010 IEEE Conference on Computer Vision and Pattern Recognition (CVPR), vol., no., pp. 950, 957, 13-18 Jun. 2010 doi: 10.1109/CVPR.2010.5540114) and the object is checked for facial features (e.g. nose, eyes and mouth) in step 904. If such features are found (YES) then the object is determined to be a face of a person in step 906. The person is then classified in step 908 based on features and parameters such as skin tone, presence or absence of hair, or ratios of distances between eyes or ears and the dimensions of the face. The classification is used to obtain demographics. These demographics may include (but are not limited to) skin tone, obesity, baldness and sex. If in step 904 the object is found not to have any facial feature, then in step 910 the object is determined not to be a face of a person, but some other object, e.g. a vehicle. The object (vehicle) is then further classified in step 912, for example as a sedan, a coupe, a SUV, a pick-up-truck, etc. The classification results from both steps 908 and 912 are stored in the database together with time and location (i.e. GPS) information in step 914 and the process ends in step 916.

### Examples of AdBeacon Use

### Static Display in Mall

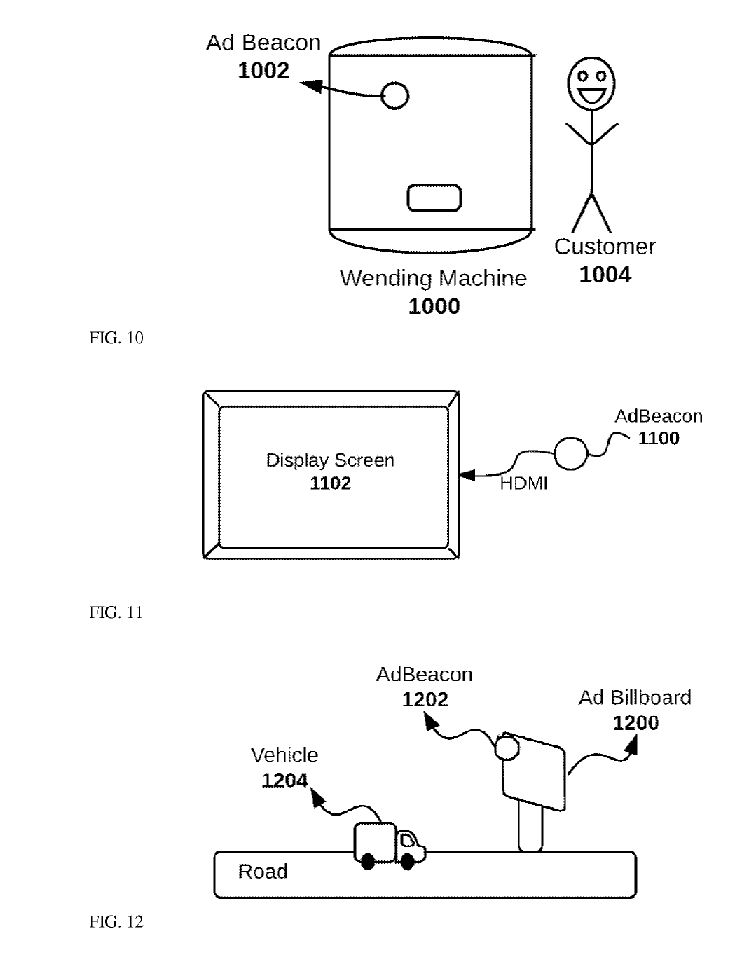

FIG. 10 shows schematically a vending machine 1000 in a mall with an ad of the Gap-brand. An AdBeacon 1002 disclosed herein takes a picture of the scene faced by the AdBeacon at predetermined time intervals (e.g. every 10 seconds), thus capturing one or more persons (potential customers) 1004 walking by the ad. These images are transferred to a server where they are processed to provide real time metrics to the advertiser. The real time metrics include the number of faces, the number of people looking at the ad (looks), and various demographics as explained above to which the ad was exposed during a time interval. Such real time metrics are not currently available in the conventional advertising market.

### Dynamic Display Via HDMI

One of the unique features of an AdBeacon disclosed herein is that any display with an HDMI input can be utilized as an electronic billboard when the AdBeacon is attached to them. FIG. 11 shows schematically an AdBeacon 1100 coupled to a screen 1102 through a HDMI connection. The AdBeacon receives ad images transmitted by the AdMobilize server based on the AdBeacon's GPS location and demographics, and displays the ad images on the screen. Thus, an AdBeacon disclosed herein performs an additional function of dynamically changing a displayed ad according to commands from a server.

### Static Display on Highways

FIG. 12 shows schematically an AdBeacon 1202 disclosed herein placed on a billboard 1200 on a road travelled by vehicles such as a vehicle 1204. The AdBeacon sends images from the road to an AdMobilize server. Algorithms and methods described herein are able to count vehicles travelling on the road during any predetermined time period and classify them to provide statistics. These statistics can then be used to assign a value of the billboard for specific ads. For example, the price of placing an ad for a brand new SUV model may be higher where there is a high traffic of SUVs.

While this disclosure has been described in terms of certain embodiments and generally associated methods, alterations and permutations of the embodiments and methods will be apparent to those skilled in the art.

What is claimed is:

1. A system comprising:
a) a beacon configured to obtain and communicate data related to a viewing session of a particular ad; and
b) a server configured to receive the data, identify in the data a human face associated with a particular person, to extract a facial feature including a gaze factor from the face, and to process the facial feature and gaze factor into metrics related to the particular ad.

2. The system of claim 1, wherein the facial features include a face dimension and a pair of eyes separated by an inter-eye distance and wherein the gaze factor includes a gaze direction relative to the particular ad.

3. The system of claim 2, wherein the facial feature processing results in a ratio between the inter-eye distance and the face dimension and wherein the metric includes a demographics metric related to the ratio.

4. The system of claim 3, wherein the demographics metric includes a person's approximate weight.

5. The system of claim 3, wherein the demographic metric includes a person's approximate ethnicity.

6. The system of claim 1, wherein the data further includes a location and a timestamp.

7. The system of claim 1, wherein the beacon in installed on a mobile or on a stationary platform.

8. The system of claim 1, wherein the beacon is further configured to display a dynamic ad on a screen in response to an input received from the server.

9. The system of claim 8, wherein the beacon in installed on a mobile or on a stationary platform.

10. A system comprising:
a) a server;
b) a display for displaying a particular ad on a screen; and
c) a beacon coupled to server and the display and configured to change dynamically the particular ad based on a command received from the server.

11. The system of claim 10, wherein the beacon is operative to acquire and communicate data related to a viewing session of the particular ad to the server, wherein the server is configured to process the data and obtain a result based on the data, and wherein the command is based on the result.

12. The system of claim 11, wherein the data includes a human face associated with a particular person and determined to have gazed at the particular ad.

13. The system of claim 12, wherein the human face includes demographics information and wherein the result based on the data includes a demographics-based metric.

14. The system of claim 13, wherein the demographics information is selected from the group consisting of sex, skin tone, obesity, baldness and ethnicity.

15. The system of claim 10, wherein the beacon in installed on a mobile or on a stationary platform.

16. A method comprising the steps of:
a) providing a beacon configured to obtain and communicate data related to an ad viewing session ad to an ad server;
b) processing the data to obtain demographics information; and
c) using the demographics information to extract a metric related to the ad, the metric being used to set a payment policy for the ad.

17. The method of claim 16, wherein the data includes a human face associated with a particular person, wherein the human face includes a facial feature, and wherein the step of processing includes processing the facial feature to obtain the demographics information.

18. The method of claim 17, wherein the demographics information is selected from the group consisting of sex, skin tone, obesity, baldness and ethnicity.

19. The method of claim 17, wherein the data further includes a gaze associated with the human face and wherein the step of using the demographics information includes determining a particular metric from the facial feature and the gaze.

20. The method of claim 19, further comprising the step of setting a pay-per-metric policy for the ad based on the particular metric.
